(19) United States
(12) Patent Application Publication
(10) Pub. No.: US 2011/0151169 A1
(43) Pub. Date: Jun. 23, 2011

(54) ADHESIVE SHEET WITH DIFFERENTIALLY THICK RELEASE COATING

(75) Inventors: Gary W. Maier, Roberts, WI (US); David J. Kinning, Woodbury, MN (US)

(73) Assignee: 3M Innovative Properties Company

(21) Appl. No.: 12/975,626

(22) Filed: Dec. 22, 2010

Related U.S. Application Data
(60) Provisional application No. 61/289,186, filed on Dec. 22, 2009.
(60) Provisional application No. 61/289,174, filed on Dec. 22, 2009.

(51) Int. Cl. B32B 33/00

(52) U.S. Cl. 428/41.8

(57) ABSTRACT

A sheet comprising a substrate having a first major surface and a second major surface, the first major surface having one or more segments of adhesive thereon and the second major surface having a release coating thereon wherein the release coating substantially completely covers the second major surface and has a varied thickness corresponding to the adhesive segments.

### CROSS-REFERENCE TO RELATED APPLICATIONS

This application claims priority to U.S. Provisional Application Nos. 61/289,174 and 61/289,186, both filed 22 Dec. 2009.

### FIELD

The present invention relates to adhesive sheets, e.g., for writing notes.

### BACKGROUND

Repositionable notes provided in sheet form, typically in a padded or stacked arrangement, are a well known organizational and communication tool. Illustrative examples of such notes are sold by 3M as POST-IT® Respositionable Notes. In a typical construction, such notes comprise a substrate such as paper having a patterned adhesive segment on the back side, e.g., typically in stripe form, and a release coating on at least a corresponding portion of the opposing front (and writing) side, such that when the notes are arranged in padded sheet form the release coating on one sheet controls the adhesion to the sheet from the adhesive segment on the bottom side of the overlying sheet.

A variety of repositionable adhesives are known, sometimes being optimized to achieve desired performance, e.g., adhesion to select substrates, stronger bond, etc. Similarly, a variety of release coating materials, sometimes referred to as low adhesion backsize or LABs are known with the selection thereof being dependent in part upon the sheet material and adhesive being used.

In some embodiments, a uniform layer of the release coating material is applied to the entire front surface of the sheet. In other embodiments in order to reduce costs, the release coating material is applied to only the portion of the front side of the sheet which corresponds to the location of the adhesive segment on the overlying sheet in the stack. In some instances, e.g., where the substrate is paper, application of the release coating material leads to discoloration of the substrate, particularly in certain relatively darker colors of paper. In such instance, if the release coating material is selectively applied only in areas corresponding to adhesive, such discoloration may lead to undesirably differential discoloration of the sheet. In addition, the presence of the low adhesion coating on only a portion of the front side may result in non-uniform writeability properties. For these reasons, strip coating of the release coating on only a portion of the front side may be unacceptable to consumers. The need exists for improved repositionable note constructions.

### SUMMARY

The present invention provides a repositionable note sheet that provides a surprising combination of advantages.

In brief summary, a sheet of the invention comprises a substrate having a first major surface and a second major surface, the first major surface having one or more segments of adhesive thereon and the second major surface having a release coating thereon wherein, in accordance with the present invention, the release coating substantially completely covers the second major surface and the thickness of the release coating varies. The thickness of the release coating varies in conformance with the pattern of the adhesive segment(s) such that when the sheet is arranged in stack form the thicker portions of the release coating correspond to the location of the adhesive pattern of overlying sheets, or when the sheet is arranged into roll form the thicker portions of the release coating correspond to the location of the adhesive pattern of the overlying portion of the sheet.

We have surprisingly found that by using such differentially thick release coatings that sheets of the invention exhibit desired release properties as well as a pleasing, uniform appearance while maintaining affordable costs. In particular, the invention permits the use of higher performing adhesives, e.g., such as are disclosed in U.S. Pat. No. 5,824,748 (Kesti et al.), in aesthetically pleasing embodiments.

### BRIEF DESCRIPTION OF DRAWING

The invention is further explained with reference to the drawing wherein:

FIG. 1 is a perspective view of an illustrative apparatus for making an adhesive sheet of the invention;

FIG. 2 is a cross sectional view of a portion of an illustrative embodiment of the invention;

FIG. 3 is a cross section view of an illustrative needle tube assembly useful for making an adhesive sheet of the invention;

FIG. 4 is an end view of an illustrative stack of sheets of the invention, and

FIG. 5 is a cross section view of an illustrative roll of a sheet of the invention.

These figures are not to scale and are intended to be merely illustrative and not limiting.

### DETAILED DESCRIPTION OF ILLUSTRATIVE EMBODIMENTS

Unless otherwise indicated, all numbers expressing quantities of ingredients, properties such as molecular weight, reaction conditions, and so forth used in the specification and claims are to be understood as being modified in all instances by the term “about”. The recitation of numerical ranges by endpoints includes all numbers subsumed within that range. As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

For purposes of clarity and without intending to be unduly limited thereby, the sheets in a group of any three sequentially stacked sheets are referenced as an overlying sheet, an intermediate sheet, and an underlying sheet with the adhesive segment(s) of the overlying sheet adhered to the front surface of the intermediate sheet, and the adhesive segment(s) of the intermediate sheet adhered to the front surface of the underlying sheet.

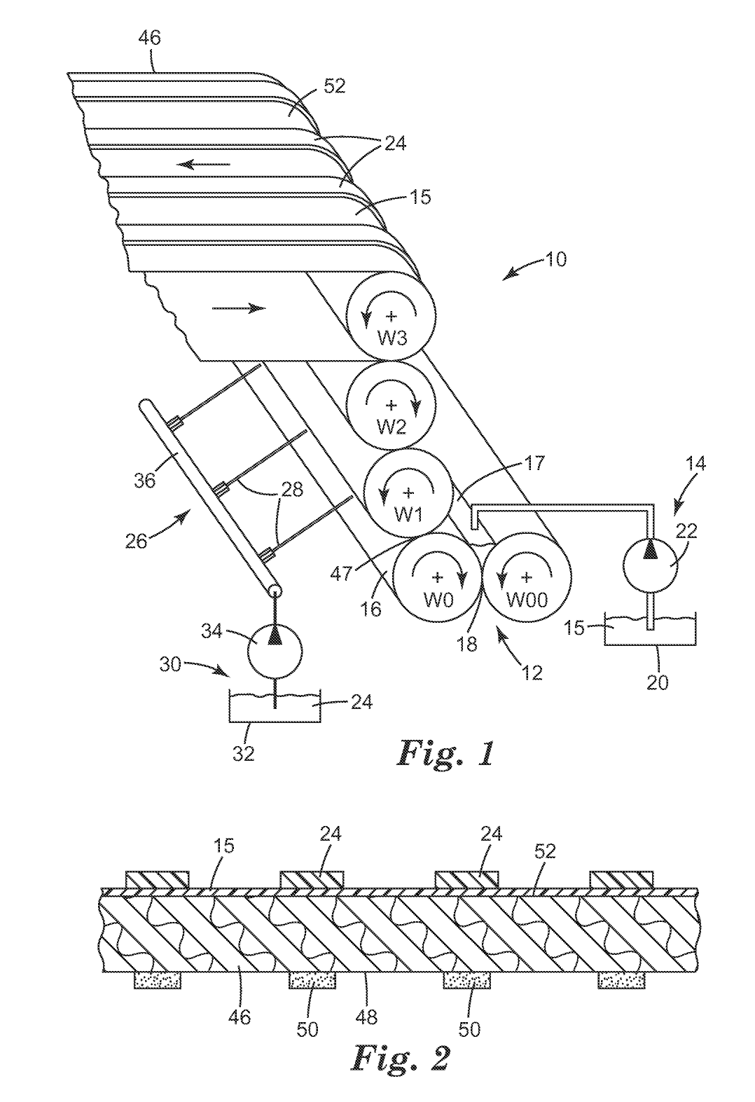

Referring to FIG. 1, an illustrative roll coater 10 is shown. The illustrated roll coater comprises a five roll coater, but it will be understood that the method of applying discreet bands of coating solution to the face of an applicator roll in a roll coater is applicable to other roll coaters such as reverse roll coaters, two roll coaters, three roll coaters, and four roll coaters.

The illustrated roll coater comprises a first coating applicator 12 having a first coating supply 14. The first coating applicator 12 applies a substantially uniform first coating 15 onto the face 16 of the W0 roll and comprises a coating pond 17 disposed in a nip 18 from the W0 roll and the W00 roll in the five roll coater. The first coating supply 14 comprises a first coating tank 20, a first coating pump 22, and piping to supply the first coating to the coating pond. Other first coating applicators 12 to apply a substantially uniform first coating 15 onto the face 16 of a coating roll can be used such as, enclosed feed or chamber doctor blade applicators, a doctor blade and a coating pond behind the doctor blade, a long slotted nozzle, dipping the coating roll into a coating pan, and a fountain coater.

After application of the uniform first coating 15 onto the face 16 of the W0 roll, a second coating 24 is applied in one or more discrete bands onto a coating roll by a second coating applicator 26. The second coating applicator 26 comprises one or more needle tubes 28 located at predetermined cross machine positions along the face of the W0 roll fluidly connected to a second coating supply 30. The second coating supply 30 can comprise a second coating tank 32, a second coating pump 34, and piping drawing the second coating 24 from the second coating tank 32 and feeding a manifold 36 to which the needle tubes 28 are fluidly connected. Other second coating applicators 26 to apply discrete bands of second coating 24 onto the face of a roll after application of the first coating 15 such as a grooved coating roll nipped with the W0 roll opposite the W00 roll can be used.

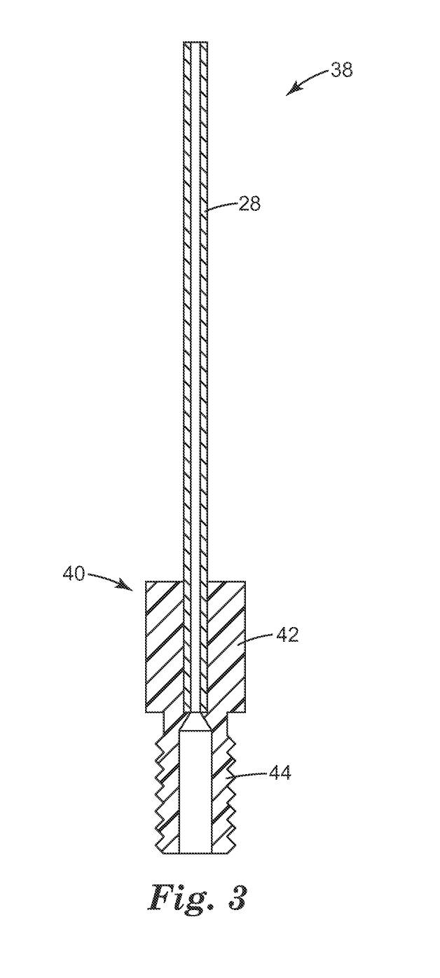

Referring now to FIG. 3, a needle tube assembly 38 comprising a needle tube 28 press fit into a coupler 40 is shown in cross section. The coupler 40 is typically made from nylon or metals such as stainless steel or brass. The coupler 40 has a hexagonal head 42 with a threaded cylindrical body 44 and a clearance hole drilled through the cylindrical body 44. A light press fit hole is drilled into the hexagonal head 42 and the needle tube 28 of the appropriate diameter and length is then press fit into the hexagonal head 42. The coupler 40 with attached needle tube 28 can then be screwed into a threaded hole in the manifold 36. Since the coupler 40 can be made from plastic and lower operating pressures are used in the manifold 36, typically no gaskets or sealants are required to prevent leaks once the needle tube assembly 38 is tightened onto the manifold 36. The needle tubes can be used with other types of couplers such as quick disconnect couplers, twist lock couplers, and bayonet couplers if desired. Such couplers are known for use when supplying pneumatic lines or hydraulic lines to machinery.

Desirably, the needle tubes 28 are made from stainless steel hypodermic needle tubing that is manufactured to make medical syringes. Other tubing materials can be used and the cross section of the needle tubes can be circular, square, triangular or other geometric shape. In one embodiment, the cross section of the needle tubes is circular. The internal diameter of the needle tubes and the length of the needle tubes can be selected based on the flow rate of the second coating 24 that is applied, the viscosity of the second coating, and the desired operating pressure of the second coating supply 30. Typically, the internal diameter of the needle tubes is from 10 mils to 100 mils (0.25 to 2.54 mm), such as from 40 mils to 70 mils (1.02 to 1.78 mm). Selection of the internal diameter of the needle tubes is more a factor of the amount of the second coating to be applied and its viscosity. Not all needle tubes connected to the manifold need to have the same internal diameter so it is possible to add more or less second coating at various cross machine direction locations.

The length of the needle tubes 28 can be adjusted to vary the manifold pressure needed to supply the desired amount of the second coating. Typically, the length of the needle tubes is from 2 to 8 inches (5.1 to 20.3 cm), such as from 3 to 7 inches (7.6 to 17.8 cm). Sufficient length is desired to produce a laminar flow of the second coating 24 in the needle tubes and to produce a minimally diverging stream of the second coating from the exit of the needle tubes as opposed to a spray or droplets such as would be produced by a spray nozzle. The stream can be continuous or intermittent (pulsed) as needed for the coating application.

Longer needle tubes can be required to direct the second coating into a nip between two coating rolls as opposed to applying the second coating onto the face of a coating roll. Generally, the needle tubes are sized to provide a second coating stream from the needle tubes at pressures from 5 psi to 20 psi (34.5 to 137.9 kilopascal); although, other pressures can be used. Enhanced cross machine uniformity on the amount of the second coating dispensed by each needle tube occurs as the length of the needle tubes is increased and the second coating supply pressure is increased.

The needle tubes can be placed to impinge the second coating stream onto the face of the coating roll. Typically such impingement would occur at an angle of less than 90 degrees to a line drawn tangent to the roll's surface at the point of impingement of the second coating stream. Generally the impingement angle between the longitudinal axis of the needle tubes and a line drawn tangent to the roll's surface at the point of impingement is from 0 degrees to 60 degrees.

Alternatively, the needle tubes can be placed to impinge the second coating stream at a nip between the coating roll and another coating roll such as the infeed nip 47 between the W0 roll and the W1 roll as shown in FIG. 1 or the infeed nip between the W1 roll and the W2 roll above the coating pond 17. By directing the second coating stream from the needle tubes into an infeed nip, improved retention of the second coating on the face of the coating roll occurs.

Additionally, it is possible to vary the second coating width that is applied to the substrate by varying the relative speeds of the coating rolls forming the infeed nip. In general, to increase the second coating width the speed of the W1 roll should be decreased relative to the speed of the W0 roll. To decrease the second coating width the speed of the W1 roll should be increased relative to the speed of the W0 roll. Retarding the speed of the downstream roll in the roll coater tends to reduce the take away rate of the second coating and spread out the second coating at the infeed nip. Conversely, increasing the speed of the downstream roll in the roll coater tends to increase the take away rate of the second coating reducing its spreading at the infeed nip. It is possible to slow down the W0 roll to such an extent that the individual strips applied to the substrate from the needle tubes merge into one another providing a continuous second coating on the substrate.

Alternatively or in combination with varying the coating roll speeds, the second coating width can also be varied by varying the amount of second coating solution supplied to the needle tubes. Supplying more second coating solution to the needles tubes will increase the second coating width while supplying less second coating solution to the needle tubes will decrease the second coating width. Following deposit of the second coating streams 24, the differentially thick coating is transferred from roll W1 to roll W2 and thereafter to the first major surface 48 of substrate 46.

The first coating applicator 12 and the second coating applicator 26 can apply the same coating solution or different coating solutions to the rolls in the roll coater. For some embodiments, the identical coating material can be applied and the amount of the first coating 15 placed onto the substrate can be adjusted in a conventional manor for the roll coater and the amount of second coating 24 placed onto the substrate can be changed by varying the pressure in the manifold 36 and size of the needle tubes 28. In some other embodiments, a similar coating material having the same active ingredients but at a different percent solids can be applied by the first and second coating applicators (12, 26). For example, a low percent solids first coating can be supplied by the first coating supply 14 to provide a low basis weight first coating 15 over the entire substrate and a high percent solids second coating can be supplied by the second coating supply 30 to provide a high basis weight second coating 24 in the stripe pattern.

A representative sheet of the invention is shown in FIG. 2, wherein substrate 46 having coatings applied to both major surfaces of the substrate is illustrated. On the first major surface 48 of the substrate, a plurality of adhesive stripes 50 is present. The adhesive stripes can be located at positions along the width of the substrate where the top edge of the finished repositionable note is cut from the substrate. On the second major surface 52 (i.e., the front or writing surface of the note), a non-uniform coating is present, typically a low adhesion coating such as a mercapto functional silicone. The non-uniform coating comprising a first coating 15 uniformly applied to substantially the entire second major surface 52 and a non-uniform second coating 24 applied in stripes over the first coating. The second coating is applied to the substrate 46 in stripes generally opposite the adhesive stripes 50 on the first major surface 48 by the needle tubes 28. Generally, the width of the second coating 24 is slightly larger than the width of the adhesive stripes 50 as can be controlled by the relative speeds of the coating rolls at an infeed nip as previously discussed.

The substrate comprises any suitable material, in most embodiments it is paper. Preferably the entire front surface of the sheet is image-receptive, most preferably writable, e.g., with pencil, pen, or marker.

As illustrated in FIG. 3, the average thickness of the portions of the release coating which are opposite to the adhesive segments are thicker than the average thickness of the other portions of release coating located between the adhesive stripes, corresponding to first coating 15 and second coating 24.

The pattern of the thick portions will preferably correspond to the pattern of adhesive segments 16 such that when sheets of the invention are arranged in padded or roll form that the overlying adhesive segments will be aligned with underlying thick portions. Typically the width of the thick portions will be similar in width to the corresponding portions of the adhesive segments. To facilitate registration, in some embodiments the width of the thick portions will be somewhat wider than the width of the corresponding portions of the adhesive segments to ensure effective release properties between sheets in a padded stack or roll. Patterned adhesive segments can be provided by a variety of known techniques, e.g., stripe coating.

As will be understood, the thickness of the adhesive segments will depend in part upon characteristics of the adhesive used as well as the desired characteristics and performance of the resultant sheet. Typically, in the case of a microsphere type repositionable adhesive, the adhesive segments will have a coating weight from 0.25 to 1.0 grams/foot². (0.68 to 2.7 grams/meter²)

As will be understood, the thickness of the thick segments and thin segments of the release coating will depend in part upon characteristics of the release coating used as well as the desired characteristics and performance of the resultant sheet. Typically, the thick segments of release coating will have a coating weight of from 2 to 80 milligrams/foot² (5.4 to 215 milligrams/meter²). Typically, the thin segments of release coating will be from 10 to 50 percent as thick as the thick segments. If the ratio is too low, i.e., the thin segments have a coating less than 10 percent as thick as the thick segments, the appearance of the front surface of the sheet and/or its writability properties may not be uniform. If the ratio is higher than indicated, unnecessary higher costs may be incurred and/or desired release properties when using high performance adhesives may not be attained.

In most embodiments, the adhesive is a pressure sensitive adhesive. In preferred embodiments it is a repositionable adhesive. Suitable adhesives may be readily selected by those skilled in the art. Illustrative examples of adhesives which may be used herein include those disclosed in U.S. Pat. No. 5,824,748 (Kesti et al).

Suitable release coating materials can be readily selected by those skilled in the art. The selection will depend in part upon the adhesive and sheet materials which are used. Illustrative examples include those disclosed in U.S. Pat. No. 5,154,962 (Mertens et al.) and U.S. Pat. No. 6,022,050 (Kline et al.).

It has surprisingly been found that sheets having the configuration of release coating and adhesive segments as described herein exhibit a pleasing uniform appearance, despite the differentially thick release layer coating. As a result, the present invention permits the use of new combinations of materials, e.g., higher performance adhesives, with water-borne release coatings, that would otherwise have resulted in aesthetically unacceptable products.

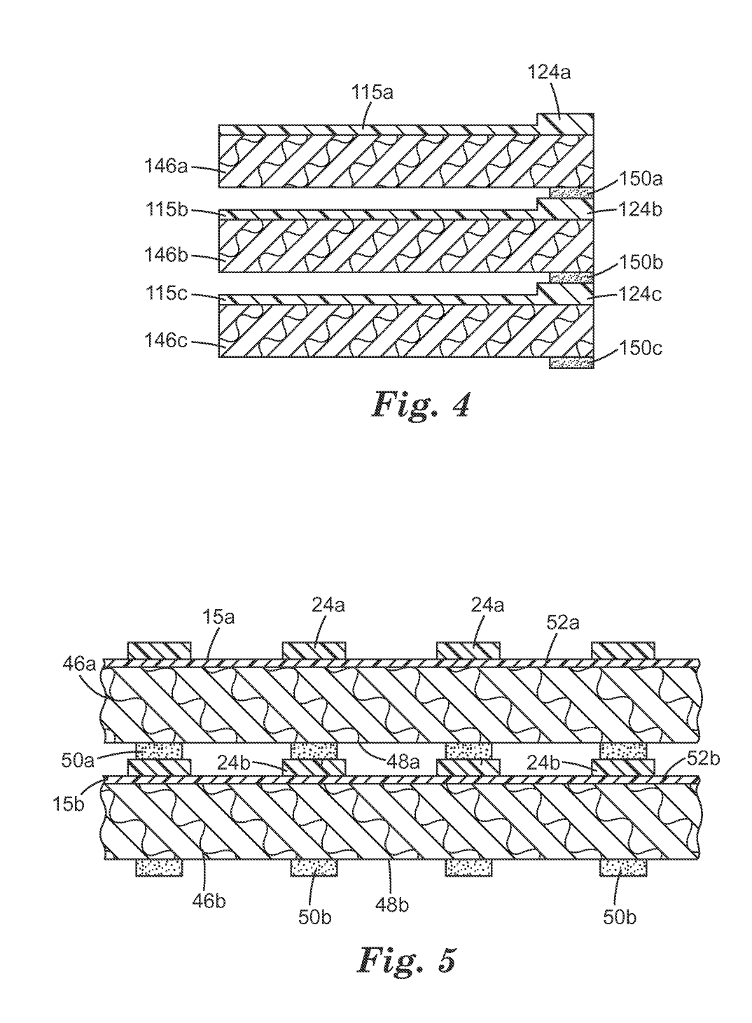

Sheets of the invention can be handled, stored, and dispensed from a variety of known configurations including, e.g., a stacked pad as shown in FIG. 4 or roll form as shown in FIG. 5. As shown in FIG. 4, when sheets of the invention are arranged in a stack of successive sheets as is commonly used, adhesive 150a of overlying sheet 146a is in contact with the thicker second coating material 124b of underlying sheet 146b. Such stacked pads of sheets can be readily made from strips of the sheet shown in FIG. 2 by conventional converting operations, e.g., slitting, chopping, and stacking Commonly, such configurations are made with sheets having a single adhesive segment as shown; however, it will be understood that padded stacks can be made with sheets having two or more adhesive segments, e.g., such as strips at opposite edges. As shown in FIG. 5, the sheet shown in, e.g., FIG. 2 can be wound upon itself into roll form with adhesive segments 50a of overlying sheet 46a oriented into contact with the thicker second release coating segment 24b of underlying sheet 46b. Such rolls may be intermediate to the converting operations leading to the embodiment shown in FIG. 4 or for use in dispensing sheets of the invention having multiple adhesive segments.

### EXAMPLES

Objects and advantages of this disclosure are further illustrated by the following non-limiting examples. The particular materials and amounts thereof recited in these examples as well as other conditions and details, should not be construed to unduly limit this disclosure. Unless otherwise noted, all parts, percentages, ratios, etc. in the Examples and the rest of the specification are by weight.

Substrate coating was performed on a five roll coater similar to FIG. 1 to demonstrate a one-step roll coating method to produce a coated substrate having a non-uniform low adhesion backside (LAB) coating on the second major surface of a paper substrate as illustrated in FIG. 3. A grape colored paper substrate was coated with the non-uniform LAB coating since stripes of this coating material is often visible on darker colored papers. To the first major surface of the paper an adhesive coat weight of 0.75 grams/foot² (2.0 grams/meter²) was applied in a stripped pattern. The adhesive comprised a composite pressure sensitive microsphere adhesive comprising two or more water insoluble polymers that are mixed wholly within the boundaries of polymeric microspheres as described in U.S. Pat. No. 5,824,748 (Kesti et al.).

The LAB coating comprised a 20% solids in water solution of a mercapto functional silicone product number KF2001 commercially available from Shin-Etsu Corporation, Japan. On the second major surface, approximately 0.020 grams/foot² (0.054 grams/meter²) of the LAB coating was applied in the stripped areas and approximately 0.010 grams/foot² (0.027 grams/meter²) was coated in areas without the stripes. To achieve this coating profile, the 5 roll coater was operated with the W0 at roughly 5% of the web speed and with W1 at roughly 70 to 80% of the web speed. Varying the W0 roll speed allows for the first coating of LAB coat weight to be adjusted, while the LAB coat weight within the second coating stripe is adjusted by the LAB flow rate (speed of pump feeding the needle tubes) and the width of the LAB stripe. Adjustment of the W1 roll speed allows for the proper spreading of the LAB coating applied by the needle tubes in order to achieve a LAB coating stripe width slightly larger than the adhesive stripe width as shown in FIG. 2.

The coated paper substrate was converted into repositionable notes using conventional converting methods. It was noted that the non-uniform LAB coating pattern did not produce visible stripes on the writing surface of the repositionable notes since a LAB coating covered the entire writing surface of the repositionable note. It was also noted that the repositionable notes were separable from the stack of notes and usable for their intended purpose without unduly sticking together. The writing ability of the repositionable notes with various pens was also examined to make sure that the writing did not appear to be any different between areas on the writing surface having the low and high LAB coating weights. No differences in writing ability were observed.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom. The complete disclosure of all patents, patent documents, and publications cited herein are incorporated be reference, in their entirety.

What is claimed is:

1. A sheet comprising a substrate having a first major surface and a second major surface, said first major surface having one or more segments of adhesive thereon and said second major surface having a release coating thereon wherein said release coating substantially completely covers said second major surface and the thickness of said release coating varies.

2. The sheet of claim 1 wherein the average thickness of the portions of said release coating which are opposite to said one or more adhesive segments are thicker than the average thickness of the other portions of said release coating.

3. The sheet of claim 1 wherein said adhesive is a pressure sensitive adhesive.

4. The sheet of claim 4 wherein said adhesive is a repositionable adhesive.

5. The sheet of claim 1 wherein said second major surface is writable.

6. The sheet of claim 1 wherein said substrate comprises paper.

7. A stack of sheets of claim 1 arranged such that the thicker portion of underlying sheet is in contact with adhesive stripe of overlying sheet.

8. The sheet of claim 1 wound into roll form.
